(19) United States
(12) Patent Application Publication
(10) Pub. No.: US 2025/0365550 A1
(43) Pub. Date: Nov. 27, 2025

(54) Apparatus, Method, and Computer Program for Rendering Virtual Reality Audio

(71) Applicant: Nokia Technologies Oy, Espoo (FI)

(72) Inventors: Jussi Artturi Leppanen, Tampere (FI); Sujeet Shyamsundar Mate, Tampere (FI); Arto Juhani Lehtiniemi, Lempäälä (FI)

(21) Appl. No.: 18/871,522

(22) PCT Filed: May 15, 2023
(86) PCT No.: PCT/EP2023/062937

§ 371 Date: Dec. 4, 2024

(30) Foreign Application Priority Data
Jun. 6, 2022 (GB) 2208275.4

(51) Int. Cl. H04S 7/00; H04S 5/00

(52) U.S. Cl. CPC H04S 7/304; H04S 5/005

(57) ABSTRACT

There is provided an apparatus for rendering an audio scene to be consumed by a listener in a physical space, the apparatus including circuitry configured to: obtain at least one information to render the audio scene with at least one audio signal according to the at least one information; obtain play-area information, the play-area information including information about a region within the physical space and within which the listener is allowed to physically move within, the play-area information including at least one of: geometry; position; orientation; and coordinate system; generate an audio rendering using the at least one audio signal in accordance with the play-area information; and obtain a rendering control parameter based on the play-area information, wherein the rendering control parameter is configured to update the audio rendering.

### FIELD

The present application relates to an apparatus, method, and computer program for rendering virtual reality audio. The rendering of virtual reality audio may be for user accessible region aware rendering of virtual reality audio signals. The present application relates to, but not exclusively to, an apparatus, a method, and a computer program for user-accessible region-aware rendering for 6-degrees-of-freedom virtual reality audio signals.

### BACKGROUND

Virtual Reality (VR) applications (and other similar virtual scene creation applications such as Mixed Reality (MR)) where a virtual scene is represented to a user wearing a head mounted device (HMD) have become more complex and sophisticated over time. The application may comprise data which comprises a visual component (or overlay) and an audio component (or overlay) which is presented to the user. These components may be provided to the user dependent on the position and orientation of the user (for a 6 degree-of-freedom application) within an Augmented Reality (AR) scene.

Scene information for rendering an VR scene typically comprises two parts. One part is the virtual scene information which may be described during content creation (or by a suitable capture apparatus or device) and represents the scene as captured (or initially generated). The virtual scene may be provided in an encoder input format (EIF) data format. The EIF and (captured or generated) audio data is used by an encoder to generate the scene description and spatial audio metadata (and audio signals), which can be delivered via the bitstream to the rendering (playback) device or apparatus. The EIF is described in MPEG-I 6DoF audio encoder input format document (N0054) developed for the call for proposals (CfP) on MPEG-I 6DoF Audio in the ISO/IEC JTC1 SC29 WG6 MPEG Audio coding. The implementation primarily is described in accordance with this specification but can also use other scene description formats that may be provided or used by the scene/content creator.

As per the EIF, the encoder input data contains information describing an MPEG-I 6DoF Audio scene. This covers all contents of the virtual auditory scene, i.e. all of its sound sources, and resource data, such as audio waveforms, source radiation patterns, information on the acoustic environment, etc. The content can thus contain both audio producing elements such as objects, channels, and higher order Ambisonics along with their metadata such as position and orientation and source directivity pattern, and non-audio producing elements such as scene geometry and material properties which are acoustically relevant. The input data also allows to describe changes in the scene. These changes, referred to as updates, can either happen at distinct times, allowing scenes to be animated (e.g. moving objects). Alternatively, they can be triggered manually or by a condition (e.g. listener enters proximity) or be dynamically updated from an external entity”.

The second part of the VR audio scene rendering is related to the physical listening space of the listener (or end user). The scene or listener space information may be obtained during the rendering (when the listener is consuming the content).

Thus for example FIGS. 1 to 4 show conventional virtual reality (VR) configurations in operation.

FIG. 1 for example shows a typical VR setup for a user. The user has set up their VR system in the room 101. The set up process can include placing VR beacons 105 115 (for tracking purposes) in the corners of the room 101 as well as defining a play area 103 for the VR system. The play area 103 in this example has been defined by the user such that there is no furniture, such as chairs 109, to bump into within the play area 103.

FIG. 2 shows schematically an example view of areas when the user 201 is consuming the generated VR content. As can be seen in this example the VR scene 203 that is being consumed is larger than the play area 103 defined within the room 101. Thus, if fully immersed in the scene, the user 201 may walk past the play area 103 and bump into a wall or chair 109 for example.

FIG. 3 shows a currently implemented solution to the problem of out of play area collisions. In such systems when the user 201 nears the play area 103 border within the room 101, they are shown a grid (mesh) 301 indicating the play area 103 boundary, thus enabling the user to remain within the play area 103 and avoid collisions with the room 101 walls or furniture outside of the play area 103, such as the chair 109.

FIG. 4 shows a currently implemented teleport operation showing the user 201 which nears the play area 103 border within the room 101 but to move outside of the play area 103 border teleports 400 to a new play area so that the ‘teleported’ room 401 has a teleported play area 403 border and teleported chair 409. In other words the play area also moves when teleporting within the play area. The user or listener's real-world position does not change during teleport, but their position in the VR scene does change. This is true for both teleporting outside of the play area and within it.

However there is a need for the audio renderer to be more aware of the user's or listener's VR play area and adapt to the play area geometry. For example to overcome the potential problem with the system in FIG. 3 where the user can be facing in a direction other than they are walking and they do not see/notice the grid. A rendered audio could thus be used to inform the user of the above situation.

### SUMMARY

According to an aspect, there is provided an apparatus for rendering an audio scene to be consumed by a listener in a physical space, the apparatus comprising means configured to: obtain at least one information to render the audio scene with at least one audio signal according to the at least one information; obtain play-area information, the play-area information comprising information about a region within the physical space and within which the listener is allowed to physically move within, the play-area information comprising at least one of: geometry; position; orientation; and coordinate system; generate an audio rendering using the at least one audio signal in accordance with the play-area information; and obtain a rendering control parameter based on the play-area information, wherein the rendering control parameter is configured to update the audio rendering.

In an example, the means is further configured to determine a play-area move, wherein the play-area move defines a translation operation of the listener and play-area together within the audio scene.

In an example, the means is further configured to update the play-area information relative to the audio scene when the play-area has been determined to move, so as to generate the audio rendering using the at least one audio signal in accordance with the updated play-area information.

In an example, the means is further configured to obtain a further rendering control parameter based on the updated play-area information, wherein the further rendering control parameter is configured to update the audio rendering.

In an example, the means is further configured to generate at least one output audio signal by audio rendering using at least one audio signal, the audio rendering based on the rendering control parameter.

In an example, the means is further configured to obtain a listener position, wherein the means configured to obtain a rendering control parameter based on the play-area information is further configured to obtain the rendering control parameter based on the listener position.

In an example, the means configured to obtain at least one information to render the audio scene with at least one audio signal according to the at least one information is configured to obtain information defining a user reachable region, the user reachable region indicating which part of the scene the listener is able to experience.

In an example, the means configured to obtain play-area information is further configured to determine a user accessible region, the user accessible region defining an intersection of the user reachable region and the region within the physical space and within which a listener is allowed to physically move within as defined within the play-area information.

In an example, the means configured to obtain updated play-area information is further configured to determine a user accessible region, the user accessible region defining an intersection of the user reachable region and the region within the physical space and within which a listener is allowed to physically move within as defined within the updated play-area information.

In an example, the means configured to obtain a rendering control parameter based on the play-area information, wherein the rendering control parameter is configured to update the audio rendering is configured to at least one of: obtain at least one audio rendering modification parameter with respect to an acoustic element within the user accessible region; obtain a rendering control parameter with respect to an acoustic element within the user accessible region relative to a further acoustic element outside of the user accessible region; obtain a rendering control parameter with respect to an acoustic element outside the user accessible region.

In an example, the means configured to obtain a rendering control parameter based on the play-area information, wherein the rendering control parameter is configured to update the audio rendering is configured to at least one of: obtain a rendering control parameter for lowering a direct-sound-to-reverberation ratio for an acoustic element outside the user accessible region in order to make them less directionally prominent; obtain a rendering control parameter for providing a higher direct to reverberation energy ratio; obtain a rendering control parameter for providing an increased distance attenuation; and obtain a rendering control parameter for providing an audio sources toggle based on a proximity threshold to the user accessible region.

According to an aspect, there is provided an apparatus comprising: one or more processors, and memory storing instructions that, when executed by the one or more processors, cause the apparatus to perform: obtaining at least one information to render the audio scene with at least one audio signal according to the at least one information; obtaining play-area information, the play-area information comprising information about a region within the physical space and within which the listener is allowed to physically move within, the play-area information comprising at least one of: geometry; position; orientation; and coordinate system; generating an audio rendering using the at least one audio signal in accordance with the play-area information; and obtaining a rendering control parameter based on the play-area information, wherein the rendering control parameter is configured to update the audio rendering.

In an example, the apparatus is caused to perform: determining a play-area move, wherein the play-area move defines a translation operation of the listener and play-area together within the audio scene.

In an example, the apparatus is caused to perform: updating the play-area information relative to the audio scene when the play-area has been determined to move, so as to generate the audio rendering using the at least one audio signal in accordance with the updated play-area information.

In an example, the apparatus is caused to perform: obtaining a further rendering control parameter based on the updated play-area information, wherein the further rendering control parameter is configured to update the audio rendering.

In an example, the apparatus is caused to perform: generating at least one output audio signal by audio rendering using at least one audio signal, the audio rendering based on the rendering control parameter.

In an example, the apparatus is caused to perform: obtaining a listener position, wherein the obtaining a rendering control parameter based on the play-area information comprises obtaining the rendering control parameter based on the listener position.

In an example, the obtaining at least one information to render the audio scene with at least one audio signal according to the at least one information comprises obtaining information defining a user reachable region, the user reachable region indicating which part of the scene the listener is able to experience.

In an example, the obtaining play-area information comprises determining a user accessible region, the user accessible region defining an intersection of the user reachable region and the region within the physical space and within which a listener is allowed to physically move within as defined within the play-area information.

In an example, the obtaining updated play-area information is further configured to determine a user accessible region, the user accessible region defining an intersection of the user reachable region and the region within the physical space and within which a listener is allowed to physically move within as defined within the updated play-area information.

In an example, the obtaining a rendering control parameter based on the play-area information, wherein the rendering control parameter is configured to update the audio rendering comprises at least one of: obtaining at least one audio rendering modification parameter with respect to an acoustic element within the user accessible region; obtaining a rendering control parameter with respect to an acoustic element within the user accessible region relative to a further acoustic element outside of the user accessible region; obtaining a rendering control parameter with respect to an acoustic element outside the user accessible region.

In an example, the obtaining a rendering control parameter based on the play-area information, wherein the rendering control parameter updates the audio rendering comprises at least one of: obtaining a rendering control parameter for lowering a direct-sound-to-reverberation ratio for an acoustic element outside the user accessible region in order to make them less directionally prominent; obtaining a rendering control parameter for providing a higher direct to reverberation energy ratio; obtaining a rendering control parameter for providing an increased distance attenuation; obtaining a rendering control parameter for providing an audio sources toggle based on a proximity threshold to the user accessible region.

According to an aspect, there is provided a method for rendering an audio scene to be consumed by a listener in a physical space, the method comprising: obtaining at least one information to render the audio scene with at least one audio signal according to the at least one information; obtaining play-area information, the play-area information comprising information about a region within the physical space and within which the listener is allowed to physically move within, the play-area information comprising at least one of: geometry; position; orientation; and coordinate system; generating an audio rendering using the at least one audio signal in accordance with the play-area information; and obtaining a rendering control parameter based on the play-area information, wherein the rendering control parameter is configured to update the audio rendering.

In an example, the method comprises: determining a play-area move, wherein the play-area move defines a translation operation of the listener and play-area together within the audio scene.

In an example, the method comprises updating the play-area information relative to the audio scene when the play-area has been determined to move, so as to generate the audio rendering using the at least one audio signal in accordance with the updated play-area information.

In an example, the method comprises obtaining a further rendering control parameter based on the updated play-area information, wherein the further rendering control parameter is configured to update the audio rendering.

In an example, the method comprises: generating at least one output audio signal by audio rendering using at least one audio signal, the audio rendering based on the rendering control parameter.

In an example, the method comprises: obtaining a listener position, wherein the obtaining a rendering control parameter based on the play-area information comprises obtaining the rendering control parameter based on the listener position.

In an example, the obtaining at least one information to render the audio scene with at least one audio signal according to the at least one information comprises obtaining information defining a user reachable region, the user reachable region indicating which part of the scene the listener is able to experience.

In an example, the obtaining play-area information comprises determining a user accessible region, the user accessible region defining an intersection of the user reachable region and the region within the physical space and within which a listener is allowed to physically move within as defined within the play-area information.

In an example, the obtaining updated play-area information is further configured to determine a user accessible region, the user accessible region defining an intersection of the user reachable region and the region within the physical space and within which a listener is allowed to physically move within as defined within the updated play-area information.

In an example, the obtaining a rendering control parameter based on the play-area information, wherein the rendering control parameter is configured to update the audio rendering comprises at least one of: obtaining at least one audio rendering modification parameter with respect to an acoustic element within the user accessible region; obtaining a rendering control parameter with respect to an acoustic element within the user accessible region relative to a further acoustic element outside of the user accessible region; obtaining a rendering control parameter with respect to an acoustic element outside the user accessible region.

In an example, the obtaining a rendering control parameter based on the play-area information, wherein the rendering control parameter is configured to update the audio rendering comprises at least one of: obtaining a rendering control parameter for lowering a direct-sound-to-reverberation ratio for an acoustic element outside the user accessible region in order to make them less directionally prominent; obtaining a rendering control parameter for providing a higher direct to reverberation energy ratio; obtaining a rendering control parameter for providing an increased distance attenuation; obtaining a rendering control parameter for providing an audio sources toggle based on a proximity threshold to the user accessible region.

According to an aspect, there is provided a computer program comprising computer executable instructions which when run on one or more processors perform: obtaining at least one information to render the audio scene with at least one audio signal according to the at least one information; obtaining play-area information, the play-area information comprising information about a region within the physical space and within which the listener is allowed to physically move within, the play-area information comprising at least one of: geometry; position; orientation; and coordinate system; generating an audio rendering using the at least one audio signal in accordance with the play-area information; and obtaining a rendering control parameter based on the play-area information, wherein the rendering control parameter is configured to update the audio rendering.

According to an aspect there is provided a non-transitory computer readable medium comprising program instructions for causing an apparatus to perform at least the following: obtaining at least one information to render the audio scene with at least one audio signal according to the at least one information; obtaining play-area information, the play-area information comprising information about a region within the physical space and within which the listener is allowed to physically move within, the play-area information comprising at least one of: geometry; position; orientation; and coordinate system; generating an audio rendering using the at least one audio signal in accordance with the play-area information; and obtaining a rendering control parameter based on the play-area information, wherein the rendering control parameter is configured to update the audio rendering.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a suitable VR setup within which a system of apparatus may implement some embodiments;

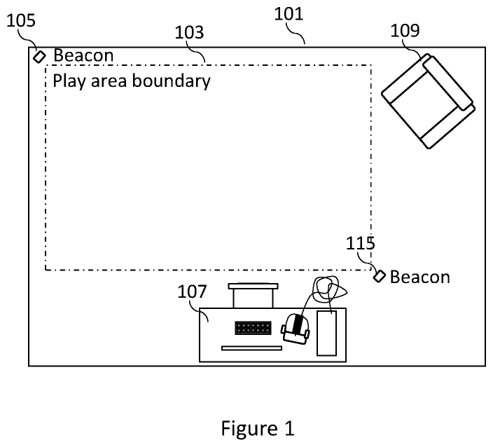

FIG. 2 shows schematically the VR setup as shown in FIG. 1 when a user is consuming the VR content;

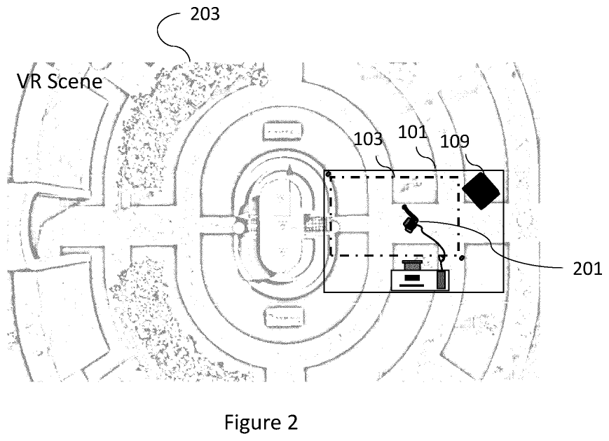

FIG. 3 shows schematically the VR setup as shown in FIGS. 1 and 2 when a user is consuming the VR content and is located near a play boundary defining a play area;

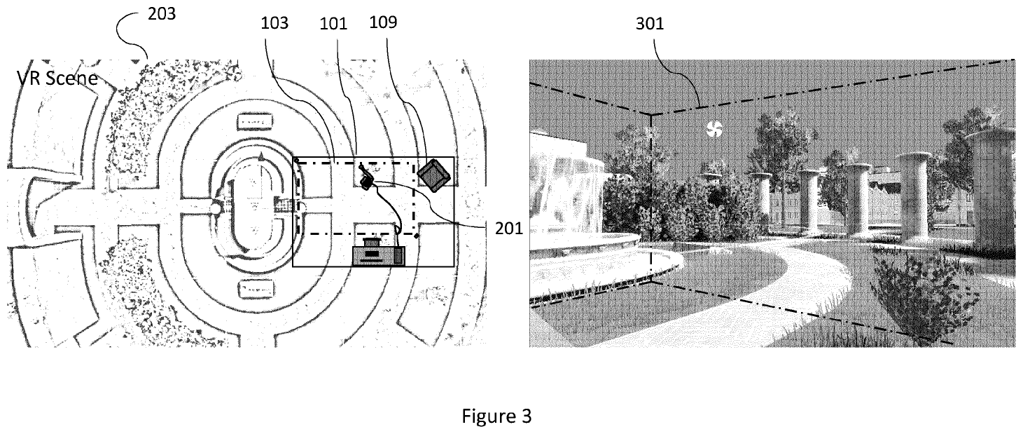

FIG. 4 shows schematically the VR setup as shown in FIG. 3 when a user performs a teleport to move outside of the play area;

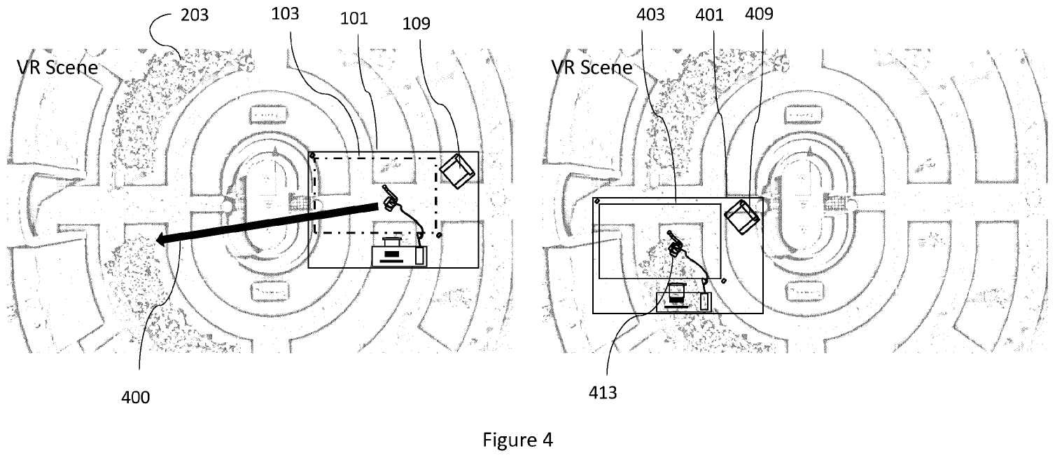

FIG. 5 shows schematically a system of apparatus configured to enable adaptation of rendering;

FIG. 6 shows schematically a flow diagram showing adaptation of rendering within the apparatus shown in FIG. 5;

FIG. 7 shows an example play area mesh definition;

FIG. 8 shows schematically a further system of apparatus configured to enable adaptation of rendering;

FIG. 9 shows schematically a flow diagram showing adaptation of rendering within the apparatus shown in FIG. 8;

FIG. 10a shows an example of how the play area position, listener position and user reachable region is incorporated into the scene representation of the renderer;

FIG. 10b shows an updated play area in the scene during teleporting;

FIG. 11 shows an example user allowed area configured by the overlap of the play area and scene or user response region;

FIG. 12 shows user positions with respect to the areas shown in FIG. 11;

FIG. 13 shows an example system of apparatus suitable for implementing some embodiments; and

FIG. 14 shows schematically an example device suitable for implementing the apparatus shown.

### EMBODIMENTS OF THE APPLICATION

The following describes in further detail suitable apparatus and possible mechanisms for enabling an audio renderer and specifically an MPEG-I audio renderer within a VR system to adjust audio rendering based on the play area geometry or the user's position with respect to the play area geometry.

As discussed above currently, a MPEG-I Audio renderer is not aware of the listener's VR play area. Thus, the MPEG-I Audio renderer is not able to adjust audio rendering based on the play area geometry or the user's position with respect to the play area geometry.

Thus for example currently it is not possible for the audio renderer to pause audio playback when the listener moves outside of the play area. This is a problem for the listener since they may accidentally move outside of the play area and bump into a wall/furniture if the user does not notice that they are outside the area. Audio pausing for example could be employed as an indicator for the listener that they are outside the area and any further movement may result in a collision. Alternatively, in some embodiments a warning sound could be rendered when the user moves outside of the play area.

Also it is not currently possible for the audio renderer to adjust rendering of audio elements (such as sound sources) depending on whether they are inside or outside of the listener's VR play area. Additionally the renderer is currently not enabled to exploit play area information for rendering optimization. For example there is a possible processing improvement where renderer could be configured to simplify directivity rendering for objects outside of the play area.

In current systems the VR rendering system overall, and the 6DoF VR audio renderer in particular, is unaware any difference or mismatch between the user reachable region (URR) (which is part of the scene description or content bitstream) and the play area (which is known in VR setups) which can be dependent on the physical space constraints or VR playback infrastructure constraints. For example there are possible regions which can be accessible in the physical play area but not accessible in user reachable region (URR) of the virtual scene. This undefined region may require special audio render processing, depending on the audio scene and which is addressed by some embodiments.

In the following examples the embodiments are described from the perspective of MPEG-I Immersive Audio systems it would be appreciated that with some further non-inventive changes the embodiments can be employed in similar 6DoF rendering systems.

The concept thus according to some embodiments is enabling a renderer to receive and process suitable play area information and perform rendering based on the play area.

Thus in some embodiments there can be employed a play area aware six degree-of-freedom virtual reality audio rendering apparatus where play area geometry, position and coordinate system information can be received by a VR audio renderer and the play area information is implemented as part of the renderer scene state information. This in such embodiments enables the renderer to control rendering based on the listener position in play area.

In some embodiments the method implemented by such apparatus can comprise the operations of:
receiving audio scene metadata and audio;
receiving play area information geometry, position, orientation and coordinate system at the renderer during initialization;
updating play area position relative to the scene coordinates after each teleport;
obtaining listener position;
obtaining at least one parameter related play area information;
determining the need to control audio rendering;
obtaining at least one audio rendering modification parameter; and
updating audio rendering according to the rendering modification parameter.

In some embodiments the play area information is provided to the audio renderer by the VR system through an interface provided by the audio renderer. The play area information furthermore in some embodiments comprises a description of the geometry of the play area as well as the position and orientation in scene coordinates. The initial position and orientation of the geometry can be provided in an initialization phase. The shape, position and orientation of the play area can in some embodiments be updated through the same interface to the renderer if play area changes, for example due to the listener teleporting. The play area information furthermore as detailed herein can be added to the audio renderer's scene state.

In such embodiments audio rendering is then adjusted by the audio renderer based on the listener position relative to the play area shape, orientation and position in the scene by lowering the gain of or muting audio elements when the listener moves outside of the play area.

Furthermore in some embodiments the concept can be to generate and provide user accessible region (UAR) information based on the obtained play area information and user reachable region (URR) information and rendering the audio signals based on the user accessible region information.

In such embodiments there can be provided apparatus and methods configured to render audio signals which are play area aware and six degree-of-freedom virtual reality where User Accessible Region (UAR) information is created based on the play area geometry (that is received and incorporated into the scene state and the user reachable region (URR) information defined in the bitstream.

Generating the user accessible region information enables the renderer to control rendering based on the listener position with respect to the user accessible region (UAR). This UAR based rendering control method can in some embodiments be achieved through the following operations:
receiving audio scene metadata and audio;
receiving play area information geometry, position, orientation and coordinate system at the renderer during initialization (and optionally updating the play area position relative to the scene coordinates after each teleport);
obtaining user reachable region URR (area defined in the bitstream which indicates the part of the scene that the user is able to experience) information;
determining user accessible region UAR (area of the scene that the user is able to experience currently (i.e. without teleporting)) information;
obtaining listener position information;
obtaining at least one parameter related to audio rendering control in UAR;
determining the need to control audio rendering;
obtaining at least one audio rendering modification parameter related to the audio rendering control; and
updating audio rendering according to the rendering modification parameter as response to the determination of the need to control audio rendering in UAR.

In some embodiments alternatively or in addition to the above, audio rendering can be adjusted or controlled by the audio renderer based on the position of audio elements in the scene relative to the play area position or the UAR. Audio elements that fall outside of the play area or UAR can be rendered for example with one of the following effects:
lowering direct sound to reverb ratio to make them less directionally prominent or a higher DDR value. This will drown the audio sources in diffuse late reverberation;
increased distance attenuation;
toggling audio sources on or off based on a proximity threshold to the play area boundary (e.g., divide sources into two groups, inside play area and outside play area). This example is different from basic proximity condition because in this case such condition is applied to play area and not predefined region in the audio scene.

In some embodiments the VR play area information comprises a mesh describing the play area geometry. The mesh may be described in a similar manner as the meshes are described in the MPEG-I Audio Encoder Input Format (EIF).

In some further embodiments information for controlling the adjusting of audio rendering based on play area geometry position relative to the user, the UAR and the 6DoF scene can be obtained from the MPEG-I Audio 6DoF metadata (delivered in the MPEG-I Audio 6DoF bitstream).

In the following disclosure the User Reachable Region (URR) can be defined as content creator created information that informs the renderer of the part of the scene that is reachable by the listener. It is received by the render from the bitstream. The region may be defined as a mesh or geometric primitive (box, sphere, etc.). This information can in some embodiments be specified in the encoder input format (EIF).

The user accessible region (UAR) can be defined as being based on the play area and the URR. The UAR can for example be defined as the intersection of the play area and the URR.

Furthermore the play area can be defined as the area in the user's consumption space which the user can use for consumption of the immersive content. This is specifically important for immersive content consumption with six degrees of freedom. The play area can be playback apparatus dependent. For example, some VR systems have a specific play area where the user's HMD (Head Mounted Display/Device) position and orientation can be tracked. In contrast, in some other systems, the play area can be less constrained or even unconstrained in some scenarios.

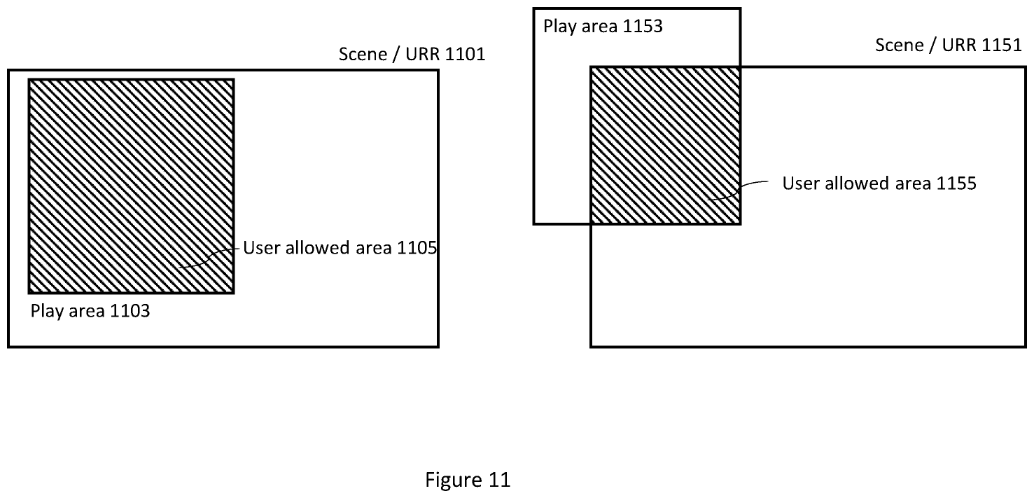

Thus for example as shown in FIG. 11 there is shown a first example wherein the scene/URR 1101 fully surrounds the play area 1103 and thus the intersection between the scene/URR 1101 and the play area 1103 is the shaded area defining the user allowed area 1105 which is the whole of the play area 1103 within the scene 1101. Furthermore is shown a second example wherein the scene/URR 1151 does not fully surround the play area 1153 but creates an intersection between the scene/URR 1151 and the play area 1153 shown as a shaded area defining the user allowed area 1155.

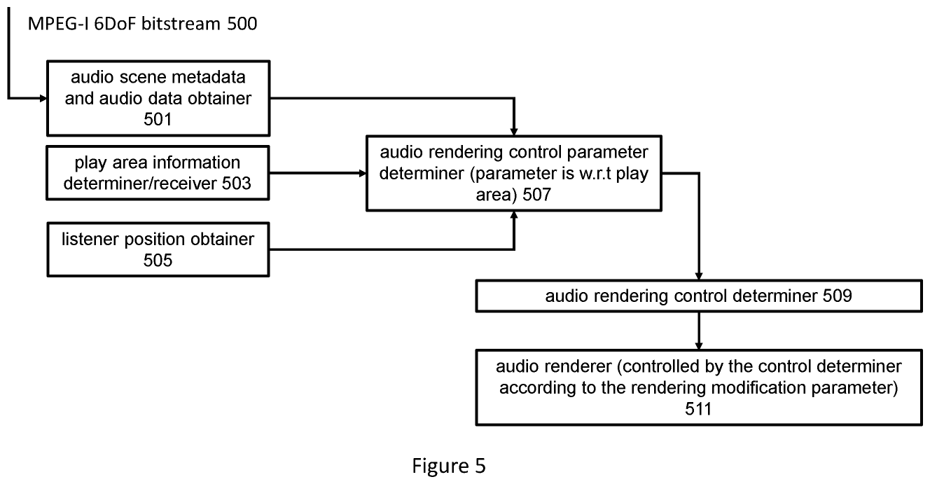

With respect to FIG. 5 is shown an example apparatus within which some embodiments can be implemented for obtaining or determining play area information and rendering adaptation based on the play area information.

For example in some embodiments the apparatus comprises an audio scene metadata and audio data obtainer 501. The audio scene metadata and audio data obtainer 501 is configured in some embodiments to receive an MPEG-I 6DoF bitstream 500 from which metadata describing the audio scene can be decoded. The metadata in some embodiments comprises information, for example, on positions and other properties of audio elements (objects, channels and HOA audio signal types). Furthermore, information (positions, properties) on other audio scene elements, such as geometries may be included. The bitstream 500 can be formatted and encapsulated in a manner analogous to MHAS packets (MPEG-H 3D audio stream), for example such as referred to within MPEG-H 3DA ISO/IEC 23008-3:2019. The bitstream 500 in some embodiments can be encoded from a 6DoF scene description format such as the encoder input format (EIF) described in MPEG-I 6DoF Audio standardization output document N0054 MPEG-I Immersive Audio Encoder Input Format.

This information can then be passed to the audio rendering control parameter determiner 507.

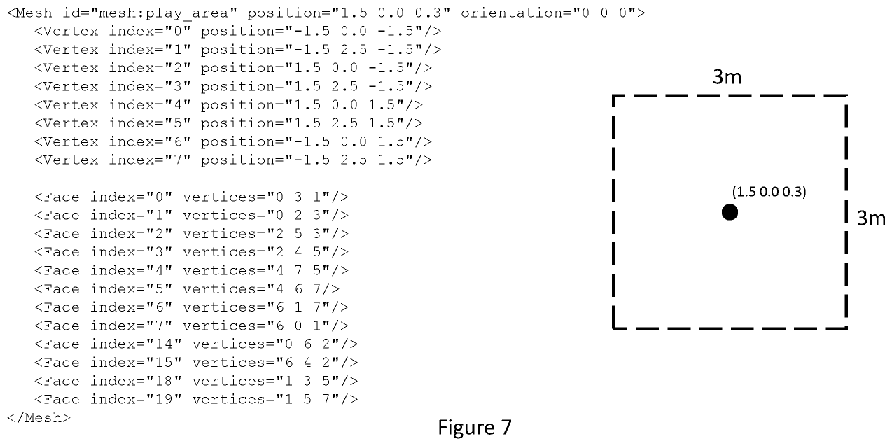

In some embodiments the apparatus comprises a play area information determiner/receiver 503. The play area information determiner/receiver 503 is configured to provide/determine play area information. In some embodiments the play area information determiner/receiver 503 is configured to provide the play area information to the audio rendering control parameter determiner by employing an API or other suitable interface. For example the play area information determiner/receiver 503 can be configured to operate in an initialization phase when the renderer is instantiated and initialized. The play area information may be described in a similar manner as geometries are presented in the EIF. An example play area mesh is shown in FIG. 7.

For example FIG. 7 shows an example play area which is a ‘cuboid’ with 3 m sides and centred at position 1.5, 0.0, 0.3. Thus the EIF mesh description features a mesh for the play area identifying the centre position and orientation and then defining first the vertex indices and related positions, and also the face indices and the vertices associated with each face.

In some embodiments the play area information is transformed into a suitable internal geometry format (e.g., such as yaw, pitch, roll) used by the renderer to represent geometries and aligned with renderer coordinate system.

This information is updated every time the user teleports or the position of the play area is changed by some other means.

In some embodiments the play area information determiner/receiver 503 is configured to employ an interface such as shown in the following example:

```
PlayAreaIngestionInterface{
  PlayAreaLocation( );
  PlayAreaExtent( );
  unsigned int(1) SceneCoordinatesFlag;
  if(!SceneCoordinatesFlag)
    CoordinatesTransformStruct( );
}
PlayAreaLocation{
  unsigned int(32) positionX;
  unsigned int(32) positionY;
  unsigned int(32) positionZ;
  signed int(32) OrietationYaw;
  signed int(32) OrientationPitch;
  signed int(32) OrientationRoll;
}
PlayExtent {
  unsigned int(32) ExtentX;
  unsigned int(32) ExtentY;
  unsigned int(32) ExtentZ;
}
CoordinatesTransformStruct{
  unsigned int(32) TranslateX;
  unsigned int(32) TranslateY;
  unsigned int(32) TranslateZ;
  signed int(32) RotationYaw;
  signed int(32) RotationPitch;
  signed int(32) RotationRoll;
}
```

In the example interface shown above PlayAreaLocation( ) describes the play area position and orientation in 6DoF scene coordinates if SceneCoordinatesFlag is equal to 1. If SceneCoordinatesFlag is equal to 0, an additional structure to transform the physical play area coordinates into 6DoF scene coordinates. This transformation information is specified via the Coordinates Transform Struct( ).

Furthermore PlayExtent( ) specifies the extent of the play area with the extent midpoint for each axis being collocated with the center of the play area. In different embodiments, the play area can be asymmetric.

In some embodiments the apparatus comprises a listener position obtainer 505. The listener position obtainer 505 is configured to obtain or determine the listener position. This can for example be determined by any suitable user input such as from the HMD or other user selection.

In some embodiments the apparatus comprises an audio rendering control parameter determiner 507. The audio rendering control parameter determiner 507 in some embodiments is configured to obtain or receive the audio scene metadata and audio data (from the audio scene metadata and audio data obtainer 501), the play area information (from the play area information determiner/receiver 503) and the listener position (from the listener position obtainer 505).

The audio rendering control parameter determiner 507 can then be configured to generate or determine at least one parameter for audio rendering control (and with respect to the play area and the listener position). The parameter in some embodiments comprises a renderer setting. In some embodiments the parameter can be directly obtained from the bitstream. The parameter can in some embodiments be configured to indicate, for example, that audio rendering is muted if the listener is positioned outside of the play area.

In addition, in some embodiments a further parameter can be determined which is configured to indicate a threshold distance from the play area border that when crossed, will cause the audio rendering to be muted or mute audio elements lying outside the play area.

In some embodiments the parameter determiner is further configured to generate a parameter configured to control audio element rendering for audio elements outside the play area such that the rendering of the audio element is made diffuse. In some embodiments the parameter is configured to control the rendering aspects such as disabling or reducing a gain value applied to the audio signals associated with the audio element.

In some embodiments the parameter configured to control audio element rendering for audio elements outside the play area (non-audio producing elements) can comprise such control parameters as: ignoring or reducing the effect of reflections; and ignoring or reducing the effect of occlusion caused by geometry elements that are outside of the play area (or outside of the user accessible region-UAR as further explained below).

The parameters can then be passed to an audio rendering control determiner 509.

In some embodiments the apparatus comprises an audio rendering control determiner 509. The audio rendering control determiner 509 is configured to determine, based on the generated parameters controls to be applied to an audio renderer 511. Thus based on the listener position and the above obtained parameter, the rendering control determiner is configured to determine whether or not audio rendering needs updating (mute or not, for example).

In some embodiments the apparatus comprises an audio renderer 511. The audio renderer 511 is configured to obtain the audio signals and the output of the audio rendering control determiner 509 and update the audio rendering.

The audio renderer 511 implementation can be any suitable rendering operation.

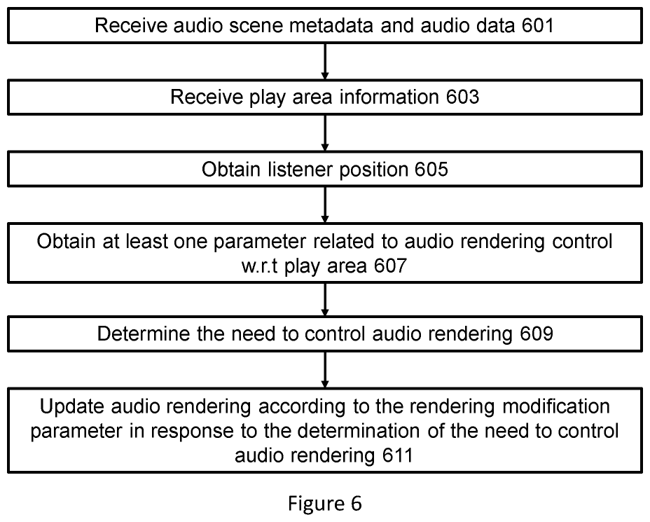

With respect to FIG. 6 the operations of the example apparatus shown in FIG. 5 are described in further detail.

Thus for example there is an operation of receiving audio scene metadata and audio data as shown in FIG. 6 by step 601.

Also there is the operation of receiving play area information as shown in FIG. 6 by step 603.

Furthermore there is the operation of obtaining the listener position as shown in FIG. 6 by step 605.

Then there is the obtaining of at least one parameter related to audio rendering control with respect to the play area (and the listener position) as shown in FIG. 6 by step 607.

Then there is an operation of determining the need to control audio rendering as shown in FIG. 6 by step 609.

Having implemented the above then the operations can comprise updating audio rendering according to the rendering modification parameter in response to the determination of the need to control audio rendering as shown in FIG. 6 by step 611.

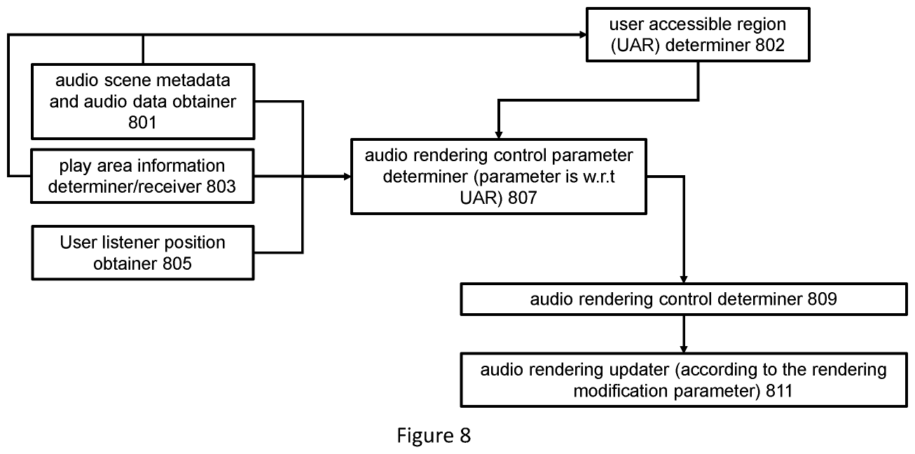

With respect to FIG. 8 is shown an example apparatus within which some embodiments can be implemented for obtaining or determining play area information and rendering adaptation based on the play area information and furthermore with respect to a user accessible region (UAR) determination.

For example in some embodiments the apparatus comprises an audio scene metadata and audio data obtainer 801. The audio scene metadata and audio data obtainer can be similar to the audio scene metadata and audio data obtainer shown in FIG. 5 and described above.

Similarly in some embodiments the apparatus comprises a play area information determiner/receiver 803 which is similar to the play area information determiner/receiver 503 described above with respect to FIG. 5.

Additionally in some embodiments the apparatus comprises a listener position obtainer 805 which is similar to the listener position obtainer 505 as described above with respect to FIG. 5.

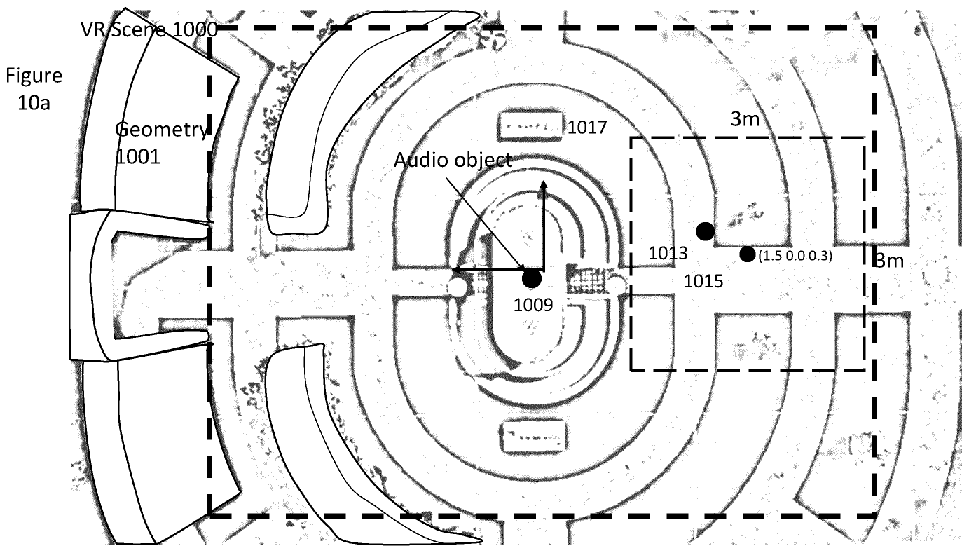

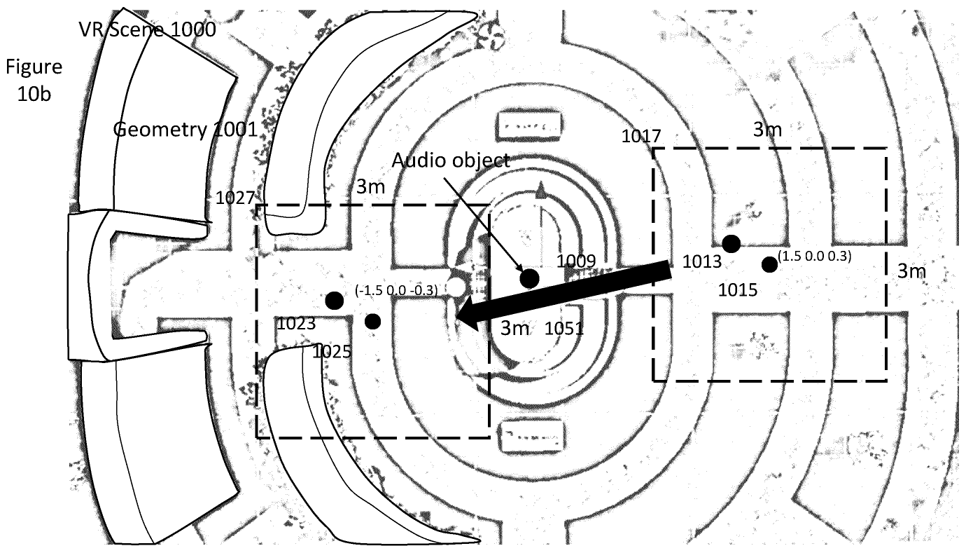

For example FIGS. 10a and 10b show example user reachable region, play area and user position in the 6DoF scene and the effect of a teleport operation. For example FIG. 10a shows an example wherein the VR scene 1000 comprises geometry 1001 and audio object 1009. Additionally in the example shown in FIG. 10a is the play area 1017 which is defined with respect to the centre point 1015 located within the VR scene 1000. Within the play area 1017 is the user 1013.

With respect to FIG. 10b is shown the scene shown in FIG. 10a but where the user or listener is implementing a teleport to a separate part of the scene. Thus the VR scene 1000 comprises geometry 1001 and audio object 1009.

Additionally in the example shown in FIG. 10b is the initial play area 1017 which is defined with respect to the centre point 1015 located within the VR scene 1000. Within the play area 1017 is the user 1013. Furthermore is shown the teleported play area 1027 based on the teleportation vector 1051. The teleported play area 1027 defined by the teleported centre point 1025 and the teleported user 1023.

Thus FIG. 10a shows an example of how the play area position, listener position and user reachable region is incorporated into the scene representation of the renderer. FIG. 10b shows the updated play area in the scene during teleporting. The same interface is used to obtain updated play area information as was used for obtaining the initial play area information. The updated information may include a new position, orientation and even a new mesh geometry for the play area.

In some embodiments the apparatus comprises a user accessible region (UAR) determiner 802. The user accessible region (UAR) determiner 802 is configured to determine the user accessible region based on the obtained play area information and the audio scene (or user reachable region-URR) information. As shown earlier the UAR can be determined as the intersection between the play area and user reachable region.

In some embodiments the apparatus comprises an audio rendering control parameter determiner 807. The audio rendering control parameter determiner 807 in some embodiments is configured to obtain or receive the audio scene metadata and audio data (from the audio scene metadata and audio data obtainer 801), user accessible region (UAR) information (from the user accessible region (UAR) determiner 802), the play area information (from the play area information determiner/receiver 803) and the listener position (from the listener position obtainer 805).

The audio rendering control parameter determiner 807 can then be configured to generate or determine at least one parameter for audio rendering control (and with respect to the user accessible region information and the listener position).

For example in some embodiments the parameter is generated based on the location of the user or listener and whether the user is within the URR, UAR or play area.

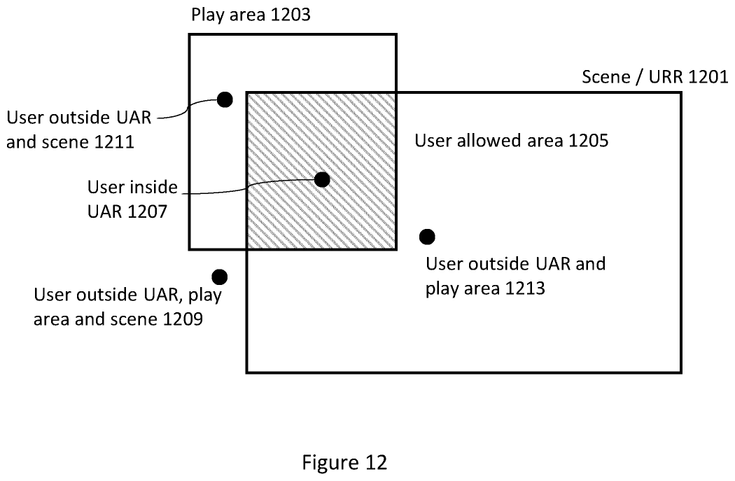

For example as shown in FIG. 12 the second example as shown in FIG. 11 is shown but where the user is

Within the UAR as shown by example position 1207;

Outside UAR and scene (but within play area) as shown by example position 1211;

Outside UAR and play area as shown in example position 1213; and

Outside UAR, play area and scene as shown in example position 1209.

For example in some embodiments the parameter generated by the audio rendering control parameter determiner 807 is an indicator as to whether to render the audio normally or mute the audio according to the following:
User inside UAR->render normally
User outside UAR->mute audio.
In some other embodiments the parameter for the renderer can be generated based on the following determination:
User inside UAR->render normally
User outside UAR, but inside play area (user in play area, but not inside scene)->render with setting S1
User outside UAR, but inside URR (user in scene, but not inside play area->render with setting S2
User outside play area and URR->render with setting S3

In the following a sample metadata description is provided to handle the different rendering scenarios:

```
  RenderingAdaptationStruct{
  unsigned int(8) listenerPositionState;
  if(listenerPositionState == 0) {//Outside URR
    OutsideURRStruct( );
  if(listenerPositionState == 1) {//Inside URR but outside Play area
    OutsidePlayAreaStruct( );
  if(listenerPositionState == 2) {//Inside Play area but outside UAR
    InsidePlayAreaOutsideUARStruct( );
}
```

The OutsideURRStruct( ) OutsidePlayAreaStruct( ) and InsidePlayAreaOutsideUARStruct( ) carry rendering parameter changes.

In absence of any additional information, the instructions in these structures can be used to modify the rendering parameters.

In some embodiments, the information can be used to update the entire scene. This can be based on a flag indicating if the change is incremental or full update. The flag can be apply_change_incrementally_flag equal to 1 indicating incremental update, indicating only the specified parameters are incorporated into the rendering (either new parameters or modify existing parameters). A value equal to 0 for apply_change_incrementally_flag indicates applying the change as an entire update overriding the current rendering parameters.

In some embodiments the audio rendering control parameter determiner is configured to obtain the parameter directly from the 6DoF metadata bitstream. For example, the behaviour of the rendering depending on whether the user is inside the play area or inside the UAR is defined can be determined from the received bitstream metadata. For example the behaviour may be authored by the content creator and is then reflected in the EIF as shown below:

```
<!-- ID for referencing play area mesh -->
<PlayAreaMesh id=“geo:play_area” geometry=$PLAYAREAMESH
position=$PLAYAREAPOSITION orientation=$PLAYAREAORIENTATION/>
<!-- URR mesh -->
<Mesh id=“URR” position=“0 0 0” orientation=“0 0 0”
    <Vertex...
    <Vertex...
    <Face...
    <Face...
</Mesh>
<!-- ID for referencing UAR (UAR is generated by renderer based on
URR mesh and the received play area mesh) -->
<UARMesh id=“geo:UAR”/>
<!-- Proximity condition to trigger when listener leaves UAR -->
<ListenerProximityCondition id=”cond:listenerOutsideUAR”
region=”geo:UAR”/>
<!-- Update only objects that are outside of the play area -->
<Update condition=”cond:listenerOutsideUAR” fireOn=False>
  <Modify id=”obj1” gainDb=”0.0” />
  <Modify id=”obj2” gainDb=”0.0” />
</Update>
<!-- Dynamic update for play area position (due to teleport) -->
<Update id=“play_area_position_udpate”>
  <Modify id=$PLAYAREAPOSITION/>
</Update>
<!-- Dynamic update for play area orientation (due to teleport) -->
<Update id=“play_area_orientation_udpate”>
  <Modify id=$PLAYAREAORIENTATION/>
</Update>
<!-- Dynamic update for play area mesh (due to teleport or
initialization) -->
<Update id=“play_area_mesh_udpate”>
  <Modify id=$PLAYAREAMESH/>
</Update>
```

In the above example, <PlayAreaMesh> defines a <Mesh> element specifically for the play area mesh. The actual geometry, position and orientation of the mesh is received via the play area mesh API.

Furthermore <UARMesh> defines a <Mesh> element that is created by the renderer based on the <URR> mesh and the <PlayAreaMesh>.

In some embodiments the play area information can come in in scene coordinates or in “room coordinates”+offset

The parameters can then be passed to an audio rendering control determiner 809.

In some embodiments the apparatus comprises an audio rendering control determiner 809. The audio rendering control determiner 809 is configured to determine, based on the generated parameters controls to be applied to an audio renderer 811. Thus based on the listener position and the above obtained parameter, the rendering control determiner is configured to determine whether or not audio rendering needs updating (mute or not, for example).

In some embodiments the apparatus comprises an audio renderer 811. The audio renderer 811 is configured to obtain the audio signals and the output of the audio rendering control determiner 809 and update the audio rendering.

The audio renderer 811 implementation can be any suitable rendering operation.

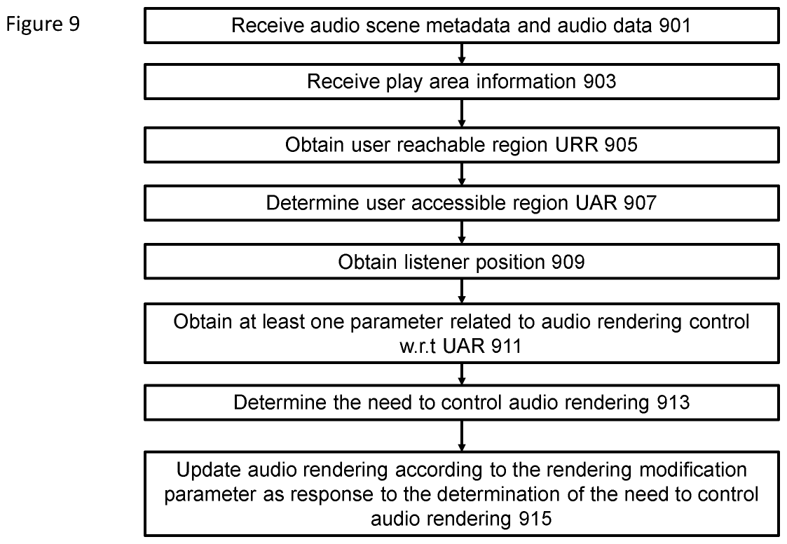

With respect to FIG. 9 the operations of the example apparatus shown in FIG. 8 are described in further detail.

Thus for example there is an operation of receiving audio scene metadata and audio data as shown in FIG. 9 by step 901.

Also there is the operation of receiving play area information as shown in FIG. 9 by step 903.

There is the operation of obtaining or determining the user reachable region (URR) according to FIG. 9 step 905.

Then there is the operation of obtaining or determining the user accessible region (UAR) according to FIG. 9 step 907.

Furthermore there is the operation of obtaining the listener position as shown in FIG. 9 by step 909.

Then there is the obtaining of at least one parameter related to audio rendering control with respect to the user accessible region as shown in FIG. 9 by step 911.

Then there is an operation of determining the need to control audio rendering as shown in FIG. 9 by step 913.

Having implemented the above then the operations can comprise updating audio rendering according to the rendering modification parameter in response to the determination of the need to control audio rendering as shown in FIG. 9 by step 915.

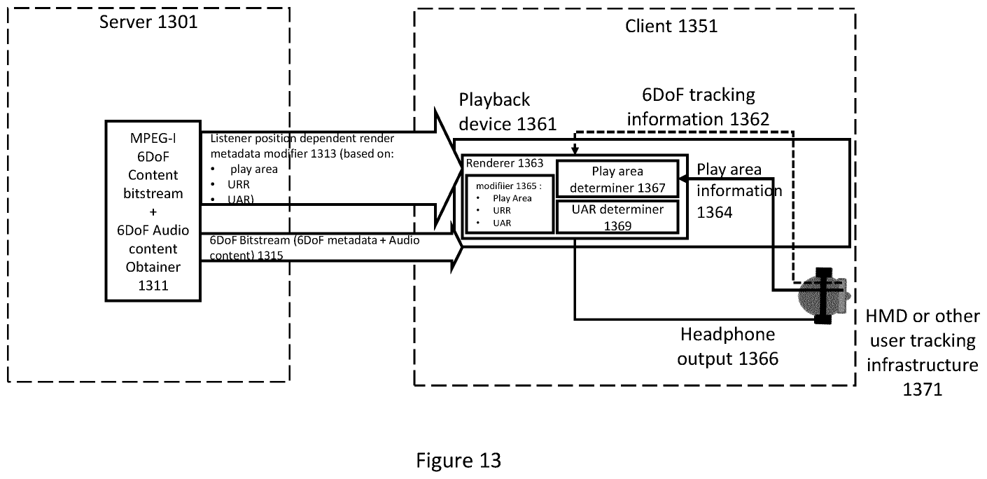

In some embodiments the aspects described herein can be employed within the example system of apparatus shown with respect to FIG. 13.

A server 1301 for example can be configured to hold or store the 6DoF rendering metadata, 6DoF audio content and the previously discussed render modification data based on the play area, URR and UAR information with respect to the listener position. Thus for example in some embodiments the server comprises a MPEG-I 6DoF Content bitstream and 6DoF Audio content Obtainer 1311 configured to obtain and supply to a client apparatus 1351 Listener position dependent render metadata modifier information 1313 (which can as discussed above be based on play area, URR or UAR) and also 6DoF Bitstream (6DoF metadata+Audio content) 1315.

Furthermore the system of apparatus as shown in FIG. 13 shows a suitable client device 1351. The client device 1351 in some embodiments comprises a play back device 1361 and optionally user tracking infrastructure 1371 associated with the playback device such as a head mounted device for tracking the head movement of the user or listener. In some embodiments the user tracking infrastructure is implemented within the playback device. The playback device 1361 thus is configured to either generate tracking information by itself or obtains via the infrastructure. The user head tracking information 1362 can in some embodiments be passed to a renderer 1363 (or more specifically a 6DoF audio renderer).

In some embodiments the playback device 1361 comprises a renderer 1363 the renderer 1363 can furthermore comprise a play area determiner 1367 configured to obtain play area information, such as from the HMD 1371. The renderer can furthermore comprise a UAR determiner 1369 and a modifier 1365.

The 6DoF audio renderer 1363 can be any generic 6DoF audio renderer or MPEG-I audio renderer.

Thus in some implementations the renderer 1363 is configured to obtain the URR from the 6DoF content bitstream (from the audio scene description), the play area ingestion information and subsequently determine the UAR (within the UAR determiner 1369). The UAR, URR and play area can then be employed to determine parameters or for controlling audio rendering based on the render modification metadata. The rendering modification can in some embodiments be performed according to the content creator specified instructions. In some embodiments, this information can also be obtained as dynamic update. Similarly the play area information can also be obtained as dynamic information during content consumption.

In some implementations the concept can be applied to other situations such as Augmented Reality AR, Mixed reality MR or XR, in addition to the virtual reality examples show above.

Furthermore in some embodiments the above concept can be employed to not only adaptation of MPEG-I audio renderer but also equally applicable to other 6DoF rendering systems.

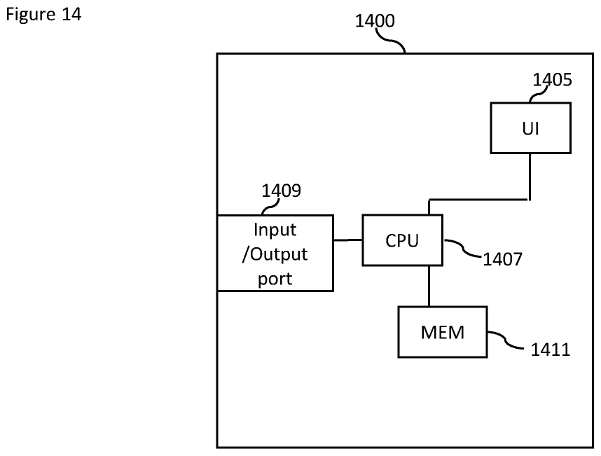

With respect to FIG. 14 an example electronic device which may represent any of the apparatus shown above (for example computer 1 511, computer 2 521 or computer 3 531). The device may be any suitable electronics device or apparatus. For example in some embodiments the device 1400 is a mobile device, user equipment, tablet computer, computer, audio playback apparatus, etc.

In some embodiments the device 1400 comprises at least one processor or central processing unit 1407. The processor 1407 can be configured to execute various program codes such as the methods such as described herein.

In some embodiments the device 1400 comprises a memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating with the position determiner as described herein.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1409 may be configured to receive the signals and in some embodiments determine the parameters as described herein by using the processor 1407 executing suitable code.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware.

The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus for rendering an audio scene to be consumed by a listener in a physical space, the apparatus comprising:
at least one processor; and
at least one memory storing instructions that, when executed with the at least one processor, cause the apparatus to:
obtain at least one information to render the audio scene with at least one audio signal according to the at least one information;
obtain play-area information, the play-area information comprising information about a region within the physical space and within which the listener is allowed to physically move within, the play-area information comprising at least one of: geometry; position; orientation; or coordinate system;
generate an audio rendering using the at least one audio signal in accordance with the play-area information; and
obtain a rendering control parameter based on the play-area information, wherein the rendering control parameter is configured to update the audio rendering.

2. The apparatus as claimed in claim 1, wherein the instructions, when executed with the at least one processor, cause the apparatus to determine a play-area move, wherein the play-area move defines a translation operation of the listener and play-area together within the audio scene.

3. The apparatus as claimed in claim 1, wherein the instructions, when executed with the at least one processor, cause the apparatus to generate at least one output audio signal with audio rendering using at least one audio signal, the audio rendering based on the rendering control parameter.

4. The apparatus as claimed in claim 1, wherein the instructions, when executed with the at least one processor, further cause the apparatus to obtain a listener position.

5. The apparatus as claimed in claim 1, wherein the instructions, when executed with the at least one processor, cause the apparatus to obtain information defining a user accessible region, the user accessible region indicating which part of the audio scene the listener is able to experience.

6. The apparatus as claimed in claim 5, wherein the user accessible region defines an intersection of the user accessible region and the region within the physical space and within which the listener is allowed to physically move within as defined within the play-area information.

7. The apparatus as claimed in claim 6, wherein the instructions, when executed with the at least one processor, cause the apparatus to update the audio rendering, and wherein the instructions, when executed with the at least one processor, cause the apparatus to at least one of:
obtain at least one audio rendering modification parameter with respect to an acoustic element within the user accessible region;
obtain a rendering control parameter with respect to an acoustic element within the user accessible region relative to a further acoustic element outside of the user accessible region; or
obtain a rendering control parameter with respect to an acoustic element outside the user accessible region.

8. The apparatus as claimed in claim 6, wherein the instructions, when executed with the at least one processor, cause the apparatus to update the audio rendering, and wherein the instructions, when executed with the at least one processor, cause the apparatus to at least one of:
obtain a rendering control parameter for lowering a direct-sound-to-reverberation ratio for an acoustic element outside the user accessible region in order to make them less directionally prominent;
obtain a rendering control parameter for providing a higher direct to reverberation energy ratio;
obtain a rendering control parameter for providing an increased distance attenuation; or
obtain a rendering control parameter for providing an audio sources toggle based on a proximity threshold to the user accessible region.

9. A method for rendering an audio scene to be consumed by a listener in a physical space, the method comprising:
obtaining at least one information to render the audio scene with at least one audio signal according to the at least one information;
obtaining play-area information, the play-area information comprising information about a region within the physical space and within which the listener is allowed to physically move within, the play-area information comprising at least one of: geometry; position; orientation; or coordinate system;
generating an audio rendering using the at least one audio signal in accordance with the play-area information; and
obtaining a rendering control parameter based on the play-area information, wherein the rendering control parameter is configured to update the audio rendering.

10. The method as claimed in claim 9, wherein the method comprises determining a play-area move, wherein the play-area move defines a translation operation of the listener and play-area together within the audio scene.

11. The method as claimed in claim 9, wherein the method comprises generating at least one output audio signal with audio rendering using at least one audio signal based on the rendering control parameter.

12. The method as claimed in claim 9, wherein the method comprises obtaining a listener position.

13. The method as claimed in claim 9, wherein obtaining the at least one information to render the audio scene with at least one audio signal according to the at least one information comprises obtaining information defining a user reachable region, the user reachable region indicating which part of the audio scene the listener is able to experience.

14. The method as claimed in claim 13, wherein obtaining the play-area information comprises determining a user accessible region, the user accessible region defining an intersection of the user reachable region and the region within the physical space and within which the listener is allowed to physically move as defined within the play-area information.

15. The method as claimed in claim 14, wherein the rendering control parameter is configured to update the audio rendering comprises at least one of:
obtaining at least one audio rendering modification parameter with respect to an acoustic element within the user accessible region;
obtaining a rendering control parameter with respect to an acoustic element within the user accessible region relative to a further acoustic element outside of the user accessible region; or
obtaining a rendering control parameter with respect to an acoustic element outside the user accessible region.

16. The method as claimed in claim 14, wherein the rendering control parameter is configured to update the audio rendering comprises at least one of:
obtaining a rendering control parameter for lowering a direct-sound-to-reverberation ratio for an acoustic element outside the user accessible region in order to make them less directionally prominent;
obtaining a rendering control parameter for providing a higher direct to reverberation energy ratio;
obtaining a rendering control parameter for providing an increased distance attenuation; or
obtaining a rendering control parameter for providing an audio sources toggle based on a proximity threshold to the user accessible region.

17-25. (canceled)

26. The apparatus as claimed in claim 1, wherein the instructions, when executed with the at least one processor, cause the apparatus to obtain a listener position.

27. The apparatus as claimed in claim 1, wherein the instructions, when executed with the at least one processor, obtain the at least one information and the at least one audio signal from a bitstream, and wherein the metadata comprises the at least one information.

28. The method as claimed in claim 14, wherein the obtaining the rendering control parameter based on the play-area information comprises obtaining the rendering control parameter based on the listener position.

29. The method as claimed in claim 11, wherein the at least one information and the at least one audio signal are obtained from a bitstream, and wherein the metadata comprises the at least one information.
